(19) United States
(12) Patent Application Publication
(10) Pub. No.: US 2006/0116900 A1
(43) Pub. Date: Jun. 1, 2006

(54) Method and system to enable, to organize, to facilitate, and to transact communications for a fee or cost born by a sender party (also known as a caller party) utilizing a network such as the internet

(76) Inventor: John Michael Jensen, Santa Monica, CA (US)

Correspondence Address: John Jensen, P.O. Box 165, Santa Monica, CA, 90402, US

(21) Appl. No.: 11/299,051

(22) Filed: Feb. 6, 2006

Related U.S. Application Data
(63) Continuation-in-part of application No. 09/776,498, filed on Feb. 5, 2001.

(51) Int. Cl. G06Q 99/00

(52) U.S. Cl. 705/1

(57) ABSTRACT

The present invention is a method and system for enabling, organizing, and facilitating the transmission of communication for a fee or cost over a network such as the Internet.

### CROSS-REFERENCE TO RELATED APPLICATIONS

Parent application Ser. No. 09/776,498

Continuation in Part application Ser. No. 11/136,888

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

This invention pertains to the fields of endeavor of data processing operations, communications, electronic commerce, electronic funds transfer, automated business practices, and communications or transmissions utilizing a network.

Specifically, this invention relates to methods and systems for enabling, organizing, marketing, and selling communication or information transmission or direction services for a fee or cost utilizing the Internet or other interactive network.

Currently many communications and transactions utilizing a network fail to be attempted, transmitted, or completed because there is no system or method for facilitating and enabling communication for a fee or cost charged to or born by a Caller party where the fee or cost benefits in part a Receiver party.

One problem is that there is no organized method or system to enable a member of the general public (“Caller party” or “fan”) with network access to transmit or to direct communication using a network to an account or address associated with a party to receive communication (“Receiver party”) where the Receiver party (or another party) charges the Caller party (or another party) a fee or cost in exchange for the right to access a Receiver party, for the Receiver party's time, advice, answer, right of address, retention, acceptance, grant of rights to the Caller party to allow Caller party to transmit or to direct communication to the Receiver party, or other rights, opportunities, material, or advantage granted by Receiver party to Caller party.

For example, no system or method currently enables a Caller party with network access to pay a fee to transmit or to direct a communication utilizing a network to a Receiver party where a part of the Caller party's fee or cost benefits the Receiver party. As a corollary, no system or method currently enables a Receiver party utilizing a network to charge a fee or cost to a Caller party or to a third party for the right to transmit or to direct communication or information to the account or address of a Receiver party such that the Receiver party benefits financially or receives consideration or benefit.

Many potential transactions and communications fail to be consummated or transmitted. Examples include current situations where a lawyer or accountant would only answer a question or read a communication if he is paid to do so. Another example is a situation where a Caller party would pay to transmit or to direct a request for a recommendation for a financial portfolio or stock but where the financial planner or broker would receive the communication or provide his service or answer only if he is compensated for his time, access, or recommendation. Another example is a situation where a Caller party would pay to transmit or to direct a request for technical assistance or support but where the technical support system or personnel would read the communication or supply an answer only if it or they are compensated. Another situation is where a Caller party would pay to transmit a request for a psychic reading or horoscope forecast that would likely only be performed if the psychic or astrologer is compensated. Another example would be a situation where a Caller party would pay to transmit communication to a famous athlete, rock musician, or fashion model but where the athlete, musician, or model is likely to read or respond to a communication only if compensated.

Another slightly different set of examples involves situations where a Caller party would pay for a response to a question, request, or query. An example is a situation where a Caller party would pay to receive a response to a certain question, a request for a personalized horoscope, or other similar personalized or individual request. These examples involve a secondary benefit or obligation in the form of a response that is in addition to the rights or benefits involving in granting access to receive or to transmit communication.

Secondly, there is no method or system existing to adequately price the right to transmit or to direct communication over or utilizing a network to the account, electronic “mailbox”, or address of a Receiver party, such as for example a publicly known or famous party such as a celebrity or famous athlete.

Problems can occur in situations where without a threshold cost to a Caller party, too many Caller parties would transmit or direct too much communication such that the Receiver party is overwhelmed or burdened. Particularly, a Receiver party would be overwhelmed if he is not financially supported or compensated for his efforts. In many cases to prevent feeling overwhelmed or burdened, a Receiver party would not provide an address, a location of an electronic “mailbox”, e-mail address, or other account or information for the public to use or to access. A Receiver party currently has no direct financial incentive to receive these communications.

Currently a party in the general public (“Fan” or Caller party) who already has network access in general may transmit or direct as many emails as he wishes of whatever length that he wishes without additional cost. While increasing the amount of communication and reducing costs is beneficial in most cases, in some cases a basically unlimited transmission or use right can negatively effect a Receiver party or create market failure because the Receiver party can be overwhelmed by the amount and length of the communication received. In some cases, there is a market failure where a Caller party does not have to pay to transmit a communication and where a Receiver party is not compensated to cover the Receiver party's costs or time associated with receiving or processing the communication. In that case, a Receiver party may choose to not provide a publicly accessible network account, electronic “mail-box” or address. In that situation, some valuable communication is doubtlessly lost, not attempted, or not completed. Because there is simply an excess demand by Caller parties for transmission or access at no cost and an inadequate or limited supply of Receiver party's time, attention, or other resources to devote to the task when not compensated so that many of these transactions, communications, requests, or transmissions will likely not occur.

A system or method that would price the right of transmission, direction, or access would improve these supply-demand and misallocation issues and provide incentive or benefits to the Receiver party to increase the supply or resources devoted to processing the transmissions and communications or to instituting a publicly addressable account or address.

It is possible that establishing a price for a currently free commodity may reduce the Caller party's demand for that commodity. In this case, pricing the right to transmit or direct communication may thereby theoretically reduce the amount of communication that would have occurred if the commodity, in this case the right to transmit or to direct communication to certain persons' accounts over or utilizing a network, remained free. But this objection is unrealistic because many Receiver parties currently do not participate in receiving transmissions or providing public access because the Receiver Parties are not compensated. Therefore the actual level of communication that currently exists of this type is greatly reduced from what would be an optimal level. The introduction of a pricing system or method and the institution of a revenue stream to the recipient or Receiver party will likely greatly increase the supply of communication because it will likely greatly increase the supply or resources of persons who are the desirable Receivers of this type of communication.

Additionally, just as the cost of a first class stamp will likely not dissuade a person from mailing a letter if he or she considers it important enough, a charge for a particular request, transmission, or communication will likely not dissuade those who consider the request, transmission, or communication important enough from transmitting even if there is an associated fee or cost to the Caller or sender party.

In an analogy to telegrams, a cost or fee borne by the Caller party may also serve to focus the Caller party's attention on the content and cause the Caller party to express the content more concisely or more clearly. If so, the more important issues may surface more readily.

Additionally, the objective of compensating Receiver parties for their efforts will encourage more Receiver parties to participate and to devote more resources to receiving transmissions and thereby increase the amount of communication.

Currently there is little ability or flexibility for Receiver Parties to differentiate communication services that they may or would like to offer because there has been little ability or flexibility to price, to offer, or to negotiate different prices or different communication or response services. For example, popular movie stars may desire to charge a fee or cost to Caller parties that is significantly greater than the charge or fee for less well-known or popular personalities.

In other cases, some Receiver Parties may wish to charge a higher price for a different service, such as for example a guaranteed response. For example, some Receiver Parties may charge twice the price for the right to a guaranteed response to a Caller party's transmission. Some Caller Parties may agree to pay more for the guarantee that a communication will be viewed or a personal response will be returned.

In other cases, some Receiver Parties may wish to charge an even higher price for a guaranteed response within a certain amount of time. Some Caller Parties may agree to pay the higher price for quicker response.

There is no current system or method that addresses situations where the Receiver party may want to charge the Caller party (or have the cost borne by a third party) for the right for a Caller party to transmit or to direct a communication to the Receiver party's account, for downloading the Caller's communication, for reading or viewing the Caller's communication, for considering the Caller's communication, for responding to the Caller's communication, for providing a content or material response to the Caller's communication, or for consideration, benefits, or rights granted in other situations.

Thirdly there's a problem where a Receiver party is unable to exploit their fame or renown in an efficient, profitable, or timely manner.

Realistically, the general public's attention span and interest is fast changing and fickle. Many Receiver Parties' fame or renown is fleeting. The window of maximum financial exploitation of their fame or notoriety can be short. Having an additional or efficient mode to exploit fame during the time period of its greatest public exposure will likely optimize the profits that can be derived from a Receiver party's renown, notoriety, or fame.

Currently, Receiver parties exploit their fame in many ways including endorsing products or services, making personal appearances, appearing in products or media or advertising, appearing in entertainment vehicles, or otherwise exploiting for profit their talents, services, name, likeness, or the public interest in them.

One problem with celebrities appearing in or endorsing products is that often it takes a significant amount of time to develop, manufacture, advertise, distribute, or make publicly available products or services. This lag time will in many cases reduce the value of the Receiver party's fame or renown as well as reduce the financial benefits the Receiver party may receive from the endorsement or affiliation. Endorsing or affiliating with products may not be the most profitable mechanism to exploit a Receiver party's fame. Additionally, the product or service itself may not de desirable and may in fact damage the Receiver party's reputation or fame.

In addition, many Receiver Parties are unable to profitably receive communication from parties in the general public (“Callers” or “Fans”). Many Receiver Parties or Receiver party's representatives have or support fan clubs that provide Caller Parties a selection of information, products, or other items for sale. Receiver Parties have had few or no direct methods to be compensated for receiving transmission of communication.

Fourthly, there is a problem where members of the general public (“Fans” or Caller parties) cannot locate an electronic or network address, electronic mailbox, or account authentically associated with a Receiver party. In this case, the Caller party has no reliable means to direct transmissions to the Receiver party (or “Star”). Many Receiver Parties are unable to make available to the general public an account, location, or address because the cost of e-mails is basically zero to a fan or Caller who has network access. Where there is no cost to the fan, the fan or Caller party would likely be encouraged to transmit many communications of great length. This leads to an impossible situation for a Receiver party because the Receiver party can not possibly view, hear, or read an unlimited amount of messages. In many cases, a Receiver party will most likely choose not to have a publicly accessible location, address, or account with which to accept communication from the public. This system failure and the Receiver party's reluctance to accept communications from the public is based in part in the market's failure to develop a system or method to appropriately price the right to transmit communication to Receiver Parties.

For example, some Caller Parties may have wanted to write or transmit an electronic message of encouragement to an Olympic athlete but the Caller party was unable to locate an address or account that was authentically associated with the Olympic athlete. Some Caller Parties may have wanted to send money or provide financial support to the athlete but there was no reliable well-known mechanism, system, or method to satisfy this demand and provide an acceptable degree of authenticity for both parties. On the other hand, the Olympic athlete who desires to receive communication and compensation must also limit the amount of time, effort, and communication involved to an acceptable level. Charging a Caller party a price to transmit or to direct communicate may filter out those Fans or Caller parties who do not sufficiently value the communication at the same time it enables more communication from those parties who value the communication more, are more excited, interested, involved, financially able, or have other desirable characteristics.

Fifthly, there is a problem where traditional revenue streams are diminished by the exchange of content over the Internet for free or without compensation or authorization to the rights holder. For example, there may be a problem where traditional revenue streams of the retail sale of music CDs are perhaps diminished by the exchange of digital music files or MP3s over the Internet for free or without compensation or authorization to the music rights holder. Receiver parties, particularly musicians, want to be able to make use of the benefits of a network such as the Internet as a revenue stream but have not yet discovered a reliable popular means to enable them to profitably do so. Enabling Receiver parties to profit from receiving transmissions of communication from their fans will provide a new and additional revenue stream that may benefit the Receiver party and may enable the Receiver party to use a network for additional financial profit.

While some Internet e-mail re-mailers, anonymous re-mailers, or pseudo-anonymous re-mailers may charge a fee to a Caller party to re-transmit the Caller party's communication to the account or address of a Receiver party, the re-mailers do not transfer funds, do not benefit the Receiver party, and do not compensate the Receiver party. Re-mailers provide the Caller party with a service of making more anonymous the source of the Caller's e-mail so that the Receiver party may not easily be able to detect who sent the communication. While re-mailer services may be useful in certain situations, re-mailers do not benefit Receiver parties, do not help locate the addresses or accounts of Receiver parties, do not provide unique addresses or accounts for Receiver parties, do not organize or limit others right to transmit communication to Receiver parties, and do not compensate Receiver parties.

Sixthly, Receiver parties need a personalized and cost effective means to control their image, to interact with Caller Parties, to make their work or thoughts better known, for fan-base building, and for cultivation of their public persona and public relations. Using traditional media such as television, advertising, infomercials, and magazines ads can be expensive and unfocused. In televisions and magazines, often too much information is distorted. The Receiver parties' depictions are often out of the Receiver party's control. Often a Receiver party desires greater control over the public depiction of his or her person, name or likeness.

Many or even most famous or publicly renowned parties are unable to efficiently advertise himself or herself, to gain greater control of their image, to communicate their individual beliefs, or to easily attract potential or new fans to learn more. Another way of attracting fans has been to appear on game shows, on the radio, on talk shows, or in other media which can be limited, uncontrolled by the famous or publicly renown party, and can have adverse effects on the Receiver party's public image.

In many cases, the famous or publicly renown Receiver party lacks the resources, time, and expertise needed to create a public venue for communication, establish or set-up billing and financial transaction processes to pay for it, or otherwise engage in a communications business, especially if the volume of communication to the famous or publicly renown Receiver party is either very high requiring a great deal of time and resources, or very low requiring significant overhead and computer costs for few revenues.

For example, it would not be practical for an Olympic athlete to prepare a network presence or WWW site during the Olympic period when the athlete is competing and most well-known and where the site or presence would authenticate credit card transactions, process payments, account for transactions, and store messages. The network and computer programming overhead is too significant, the timing to set-up the site too lengthy, and the time period of fame too short to make a feasible business proposition and enable the Receiver party to lead the life for which he or she is famous or renown.

Seventhly, Receiver parties need a means to counter unauthenticated WWW sites and to authenticate their identities to Caller Parties over a network. Receiver parties need to be able to be associated with a system or method that provides Caller party with a certain degree of reassurance that the communications that they transmit will be directed to an address or account that is associated with the authentic Receiver party or organization. Currently, there are too many “fake” sites, unauthorized fan sites, and others who wish to profit from a Receiver party's name or likeness without being authentically associated with Receiver party.

Eighthly, there is less than an optimal amount of interaction or information exchanged between Receiver parties and Caller parties, especially in cases of Caller Parties requesting professional services where Receiver Parties traditionally expect to be paid or compensated for their time, services rendered, or information provided. There is currently no timely network system or method or means that increases the amount of professional services transacted over an interactive network such as the Internet, that provides a method to compensate the Receiver party for the services rendered or communications received, or that increases the amount of time-sensitive important communication over a network especially in “e-mail” or text based professional services, such as accounting or law.

Additionally, Receiver parties want to be able to personally interact with Caller parties on an informed basis yet not bear all the costs of the communication. Caller parties want to interact with Receiver parties. Receiver parties may to interact with Caller parties but do not want to make themselves vulnerable or overwhelmed.

Ninth, Receiver parties need to protect their privacy. They need to be able to control how others communicate with or access them.

Tenth, the organization and development of the market for personalized communication, transmission, or direction of communication for a fee or cost borne by a Caller party is stalled without a system or method to price, to differentiate, to develop, and to organize the market so that a Caller party may more easily pay a fee or bear a cost which directly or indirectly benefits the Receiver party.

Eleventh, too little quality communication is exchanged currently and too much unconsidered communication is misdirected or poorly directed without a mechanism to channel and focus the communication. In electronic communication, often you get what you pay for. If the communication costs almost nothing to compose, it may be worth almost nothing. Creating an option where people may pay an amount for valuable access or information allows people the option to access a greater amount or quality of information, greater flexibility, greater specificity in responses, and greater sophistication while still leaving the vast majority of electronic communication to remain free of additional obligation or cost.

Twelfth, Caller parties or Fans are entitled to feel that they have received something tangible or of value for their funds expended to transmit or direct communication to others. One problem involves a consumer's perception that he or she has been “ripped-off” because he or she has not received a response to a transmission that he or she paid to transmit. This problem can be lessened or averted by providing additional value to Caller parties in excess of the value of the opportunity or right granted to the Caller party to transmit communication to the account or address of the Receiver party. For example, this additional value could be an immediate automated response listing pertinent information that is immediately sent to the Caller party. While an automated immediate response is valuable, it is perhaps not exactly a solution to the Caller' party's specific request.

Lastly, many smaller transactions do not currently occur because of high transaction costs, inadequate information, and inefficient markets for smaller transactions. For example, there is perhaps a huge market for electronic newsletters about specific subjects that has not developed because of the high transactions costs for securing payment for the relatively small per usage or subscription fee. These transactions would be beneficial if they occurred.

The present invention solves these problems and more.

There is no information or specific documents known to me that relate to the present invention.

### BRIEF SUMMARY OF THE INVENTION

The present invention is a method and system for enabling, organizing, pricing, selling, transacting, and facilitating communications for a fee or cost utilizing a network, such as the Internet.

In essence, the present invention enables a Merchant Intermediary with a network presence to function as an organizer, marketer, market maker, broker, salesman, sales venue, endorser, agent, transmitter, cashier, service provider, common carrier, or authenticator of communication from Caller parties (or “Fans”) in the general public to accounts, mailboxes, or addresses associated with Receiver parties, including famous or renowned Receiver parties (“Stars”), where a fee or cost is directly or indirectly charged to, borne by, or debited against a Caller party (or a third party) in a manner such that the fee or cost directly or indirectly benefits, in whole or in part, the Receiver party.

With the increasing popularity of the Internet and the World Wide Web, it has become more common for Caller parties or “fans” to want to personally direct communication to Receiver parties or “Stars”.

Receiver Parties increasingly want to exploit the benefits of a network such as the Internet as a new or additional media, distribution tool, revenue stream, or public relations mechanism.

Currently there is no system, method, means, or service to organize a market for directing communication for a fee or cost that addresses these demands.

In cases of Caller Parties or fans addressing communication to famous Receiver Parties, the present invention offers a Caller party or Fan an opportunity to transmit or to direct communication to a location, electronic mailbox, address, or account that is verified to be one associated with a Receiver party. The present invention offers Caller party or fans the opportunity to direct a transmission that the Receiver party may read or view, an opportunity that the Receiver party will personally respond to the Caller party's communication, and an opportunity for the Caller party to financially support or compensate the Receiver party. Because the Receiver party is financially compensated, the Caller has greater reason to believe that it is more likely that the Receiver party will view the Caller's transmission and potentially respond.

The Caller party benefits from financially supporting the Receiver party, benefits from some degree of assurance that the Caller's communication will be transmitted to an account that is authentically associated with the Receiver party, and benefits in that the Caller party will only be billed or charged as agreed in the terms and conditions set forth on the Merchant Intermediary's web site or network presence.

The system and method promote greater flexibility in pricing and services offered. For example, the system and method provide great flexibility in pricing, services provided, timing, guarantees, level of service, and quality of information or response desired or received. The Receiver party can generate different prices for different services or rights granted. The Caller party can choose which rights or level of service that the Caller party needs or desires. For example, the two parties can make a contractual arrangement through the Merchant Intermediary's web site, where most of the terms will be automated but specific to the variables involved in the substance of the communication. For example, if a Caller party needs advice on a payroll matter in 2 hours and a Receiver party charges $20 for a guaranteed response on a payroll matter in 2 hours, the two parties may reach an agreement based on the terms and conditions posted by the Receiver party on the Merchant Intermediary's web site. For different terms, prices, or conditions, the Caller party may want to investigate what terms, prices, or conditions other Receiver Parties offer for the same advice, services, or communications.

In the preferred embodiment of the present invention, the stage or time in the system or method when the Caller party incurs a cost or fee occurs at the stage or time of the Caller party's agreeing to transmit or direct the communication to the account, address, electronic mailbox, or address associated with the Receiver party even though the cost, obligation, or fee borne by the Caller party may be additionally or also associated with or contingent upon other rights, conditions, or advantages conferred on the Caller party at a later or subsequent time. Although the system and method contemplate that the Caller party's initial billing or account information will be collected or processed at the stage or time of the Caller party's initial transmission or direction of the communication to the Receiver party's account, the system and method enable both Parties significant flexibility in choosing the services rendered including the ability to differentiate and to price different services.

For example, the present invention addresses situations where for example the Receiver and the Caller party may agree that the Receiver party may charge the Caller party or another party one or more fees, costs, or obligations for the right to allow a Caller to transmit a communication to the Receiver party's account, for downloading the Caller party's communication, for reading or viewing the Caller's communication, for considering the Caller's communication, for responding to the Caller's communication, for providing a content or material response to the Caller's communication, for providing an answer within 2 hours, or in other situations, scenarios, grants, or transactions.

The Receiver party benefits because he or she is enabled to receive electronic communication that a Receiver party may otherwise not receive, to determine and to set a price for receiving transmissions or directions of communication to the Receiver party's account, to sell and to market on a larger scale the right to access the Receiver party, to receive compensation for receiving communications or participation, to exploit a new or additional revenue stream, to return communicate with select Caller Parties if the Receiver party desires, to develop and to address a Fan base, and to more easily and more directly profit financially from the Receiver party's fame, public attention, or public inquiries.

The present invention offers a Receiver party a potentially substantial new revenue stream which could more than meet costs associated with receiving the communication, increase the amount of information or personal communication a Receiver party has with his or her fans, and compensate or reward the Receiver party for their knowledge, their participation, or their services.

The system and method enables the Receiver party to receive compensation for granting others the right to transmit communication to an account, mailbox, or address associated with the Receiver party (whether or not the Receiver party responds to the Caller's transmission or communications), to profit from their fame or knowledge in a unique or additional means, to offer access to those Caller parties with sufficient interest or finances to pay for the right to transmit communication, to generate revenue to cover the associated costs of communicating with others, to develop and to address those Caller parties interested in the Receiver, to offer a public means by which the public may access them, and to receive communication or information they may not otherwise receive.

The general public benefits from gaining access to persons whom the public might otherwise not be able to access, from organization of a market, from facilitating communication, from increased communication, from the opportunity or method to make potentially smaller transactions or transfers, and from introducing a system or method that addresses and improves current market failure in directing communication to other parties, market inefficiency due to high transaction costs, and market disorganization due to a lack of information or structure.

The system and method of the present invention provide a framework for facilitating smaller transactions and thereby increase the amount of desirable communications or transactions, decrease overall costs, improve the quality and amount of information available, provide incentive for more parties to participate or communicate, and provide value to society.

In the preferred embodiment of the system and method, the merchant web site can organize, formalize, or facilitate a market for transmission or direction of electronic communication for a fee or cost, improve information services or transfer between unassociated parties, organize or funnel demand for transmitting communication to a particular Receiver party, more efficiently process and authorize financial transactions of smaller amounts between unassociated parties, more efficiently process and organize communication to a specific Receiver party, and more efficiently process and account for fees, expenditures, and compensation.

There are likely significant economies of scale to be realized in the formation and development of large centralized communication transmission services as disclosed in the present invention. If these economies of scale prove correct, then the method and system will facilitate increased communication, increase knowledge, decrease costs, and enable parties to learn or hear things that they would not otherwise know or hear. For example, it is likely that a significant majority of famous or publicly renown persons could not operate individual network sites which involve payment or compensation and have those businesses prosper because of the high overhead costs and market inefficiencies of small or diffuse sites.

Additionally, Caller parties or Fans are entitled to feel that they have received something tangible or of value for their funds. This problem can be addressed by providing an additional benefit or consideration in return for the Caller's paying for the right to transmit or direct communication. For example, the Merchant Intermediary could also generate a response or an authenticated unique response to the Caller party that will in some way have value as a collectible or other good or material to the Caller party. The return communication could be a graphic, photo, electronic signature, uniquely modified communication, or other transmission or communication that supplies a value in return for the Caller's payment of a fee or cost even in situation where the Receiver party does not personally read or return personalized communication to the Caller party.

The system and method of the present invention is more valuable and useful than just a “pay-per-email” service. One real power and usefulness of the system and method is that it focuses consumer demand so that resources can be more efficiently allocated, better uses a network's ability to inform and direct, organizes markets, provides more cost-effective services, reduces transaction costs, organizes information, and funnels demand.

In the preferred embodiment, the method and system facilitates communication of all types and kinds, including communication consisting of one or more types or kinds of text, audio, images, video, voice, graphics, or music in electronic or digital form.

The system and method is not limited to “e-mail” and has application to all areas of communication or transmission including voice, video, audio, interactive television, auctions, radio, telecommunications, paging, wireless communications, the internet, internet chat, two-way cable service, broadcasting, and satellite communications. The system and method have application whenever 2 or more devices or means directly or indirectly communicate or transfer data by means of a network, through transmissions, or through an intermediary device or means.

### BRIEF DESCRIPTION OF THE SEVERAL VIEWS OF THE DRAWING

These and other features and advantages of the invention will now be described with reference to the drawings of certain preferred embodiments, which are intended to illustrate and not to limit the invention, and in which:

FIG. 1 is a high-level architectural drawing illustrating the primary components of a system that operates in accordance with the present invention.

FIG. 2 is an architectural drawing and flow diagram illustrating the network presence site or location of the Merchant Intermediary and illustrating the steps or processes of the method.

### DETAILED DESCRIPTION OF THE INVENTION

There are many ways to implement the method or system for enabling, organizing, facilitating, and transacting the transmission or direction of communication for a fee or cost utilizing a network such as the Internet.

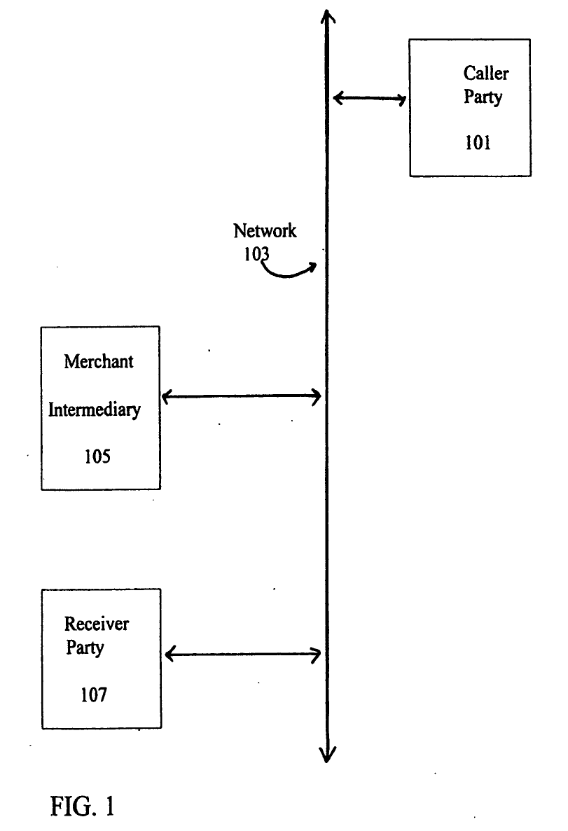

More specifically, the present invention provides a system and method to enable parties in the general public with network access 103 in FIG. 1 to visit the network presence site (or “server”) or address (“URL” or “Uniform Resource Locator”) of a Merchant Intermediary 105.

The method and system assumes that Caller parties, Receiver parties, Merchant Intermediaries, and other parties have network access through means such as, for example, an Internet service provider (ISP), wireless, cable modem, backbone provider, or other means or ways to access a network such as the Internet.

The preferred embodiment of the system and method also assumes that the Receiver parties and the Caller parties have traditional email accounts services and addresses which are serviced by traditional e-mail servers, destination mail servers, submission mail servers, or other means.

The incorporated drawings and figures do not show or describe the type or kind of network access. The incorporated drawings and figures also do not show or demonstrate the type or kind of traditional mail servers that the system and method assumes that the Receiver or Caller parties have because traditional mail servers are not required in the preferred embodiment of the system and method.

The Merchant Intermediary 105 in FIG. 1 establishes and maintains a network server or web site that is located on a “host” or “networked” computer with network access 103. In the preferred embodiment, a Caller party 101 in FIG. 1 accesses the Merchant Intermediary's server or web site via the Caller's home, office, or remote Computer or device 101 using the Caller party's network 103 or Internet access and a conventional Web browser or e-mail client such as Eudora or Outlook which communicates with the Merchant Intermediary's network server or Web site using HTTP, e-mail, or other standards or protocols.

In the preferred embodiment, the Merchant Intermediary's web site or specialized pages within the Merchant Intermediary's web site may also be accessed by or through third party web sites, Internet portals, associated networks, search engines, other devices, or other means, services, locations, entities, or references.

Once the Caller party's computer transmits a request for information to the Merchant Intermediary's server, the Merchant Intermediary's server will respond and transmit information back to the Caller party's computer or device that displays on the computer screen of the Caller's computer or device. In the preferred embodiment of the present invention, the Merchant Intermediary's network site or server computer can transmit data that will display on the Caller's computer or device as hypertext, a linked list of the Receiver party's names and associations, a database or search function that enables the Caller to query the host's database and to match the Caller-supplied references with references in the Merchant Intermediary's database, a frame or other format, as data in the Merchant Intermediary's database in a hypertext or linked alphabetical manner, or a combination of these or other types or forms of data or display.

In the preferred embodiment, the names or associations of Receiver parties 107 are hypertext or linked on the Merchant Intermediary's web site to enable the Caller 101 to “click” on a name or reference of a Receiver party on the Merchant Intermediary's web site 105 and to receive information related to that Receiver party. Using current protocols, a Caller's “click” on the hypertext link on the Merchant Intermediary's web site causes the Caller's Web browser to transmit the associated URL on the Internet via a standard HTTP message to the Merchant Intermediary's server (or a third party's server) that access HTML documents on the Merchant Intermediary's server (or a third party's server) and transmits information back to the Caller party's computer for display in the browser or other program or application on the Caller's computer screen.

In the preferred embodiment of the system and method of the present invention, the Caller party 101 then searches or finds on the Merchant Intermediary's server 105 the Receiver party's address, account, location, electronic mailbox address, or other information required to access a Receiver party 107 or required to transmit or direct communication to the Receiver party's associated accounts, addresses, or electronic mailboxes.

The searching or finding function or feature on the Merchant Intermediary's web site or network presence 105 can be implemented in a number of ways, including a searchable database, an alphabetical listing of Receiver party's names or associations, a graphic interface of images, a display including clickable hypertext, a hierarchical menu of references, or other database, search, organization, finding, or display forms, types, or programs.

When the Caller has found the Receiver party's name, address, or reference on the Merchant Intermediary's web site or network presence 105, the Caller party 101 learns that a Receiver party 107 has agreed to participate or to receive communications for a fee or cost and under or contingent to certain conditions, prices, fees, costs, consideration, obligations, terms, agreements, or other variables that are listed or incorporated with the listing, name, or reference. A Caller party 101 can compare terms, conditions, prices, and variables within the different services or rights that a single Receiver party 107 posts or offers or a Caller party may compare the terms, conditions, prices, and variables that different Receiver parties offer or post.

Under specific or unusual circumstances, a Caller party 101 in FIG. 1 may propose through the Merchant Intermediary 105 to a Receiver party 107 different terms, conditions, prices, or variables than those that a Receiver party has posted or offered. The Receiver party 107 can then accept, counter-offer, ignore, or reject the proposal. Most often, in the preferred embodiment, the Caller party 101 will choose to acquire the right to transmit or direct communication to a Receiver party 107 based on the price offered or posted by a Receiver party on the Merchant Intermediary's web site 105.

The Caller party 101 then clicks on or otherwise chooses a service or communication that the Caller party desires from the range of choices posted on the Merchant Intermediary's web site or network presence 105. The Caller party's choice or action also forms a legally binding agreement between the various parties, prompts an additional request to form a legal agreement, establishes the terms and conditions of the use and transaction, or otherwise establishes a contract or agreed upon terms and conditions that govern the arrangement or transaction.

In the preferred embodiment, after the Caller party 101 chooses the specific service, rights, and corresponding agreement, the Caller party may then compose, incorporate, edit, format, create or otherwise work on or with a communication intended for the Receiver party 107 using functionality supplied or provided by the Merchant Intermediary 105 on its web site.

The functionality that the Merchant Intermediary 105 provides that enables a Caller party 101 to compose, incorporate, edit, paste, create, send, format or otherwise work on or with a communication to the Receiver party 107 can be accomplished in many ways.

For example, in the preferred embodiment the communication can be composed, edited, formatted, created, sent, or pasted by many means or in many ways including a message being composed as a standard e-mail communication by the Caller party's client or e-mail application and sent to the web-based mail server-associated with the Merchant Intermediary, typed in as text in a form on the Merchant Intermediary's web site or network presence, pasted in and formatted as a text message on the Merchant Intermediary's web-based mail server, entered as text in a java applet, transmitted to the Merchant Intermediary as a MIME compliant message, forwarded to the Merchant Intermediary as an e-mail message, created as a HTML page, imported or edited or composed as a graphic, spoken as voice or audio, or composed, edited, formatted, or otherwise created or worked on as a combination of these or other forms, formats, or types.

The composition/editing/formatting function can be accomplished in a number of ways including as a simple text input function or means in a client-server paradigm, as a word processing application, incorporated or imported from or as part of a Caller party's existing application, client or browser software, as a java applet or similar application, as a form in HTML page, as a text input means or form on the Merchant Intermediary's web site or network presence, as a graphics program, as a mail program or server on the Merchant Intermediary's web site or network presence, or as a combination of these or other means, programs, implementations, applications, or functionality. Many web-based mail servers use a traditional-web browser and a text input form to enable users to input text, addresses, or a message on a web site server.

The transmission, direction, sending, or forwarding function can be accomplished in a number of ways including a communication being received or forwarded with or from a Caller party's existing client or browser software, with a java applet or similar application working with the Merchant Intermediary's web site or network presence, with or form a mail program or server, or with or form a combination of these or other means, programs, implementations, applications, or functionality.

After composing, creating, formatting, editing, or otherwise working on or with the communication, the Caller party agrees to pay a fee or bear a cost before the Caller party is allowed to transmit or to direct the communication to the account, address, mailbox, location or storage area associated with the desired Receiver party.

The web site or network presence of the Merchant Intermediary 105 queries the Caller party 101 via the network 103 for information needed to transact or process payment or identify the Caller party. The web site or network presence of the Merchant Intermediary 105 establishes or consults an account for identification and processing payment with respect to the Caller party 101 and requests and receives the needed or desired information from the Caller party that is required for the Merchant Intermediary 105 to transact or to process payment. After the Merchant Intermediary 105 has either established an account for the Caller party 101 or found the Caller Party's pre-existing account, the Merchant Intermediary then begins to process payment, authorize transactions, bill or query the Caller party's or a third party's account or obligation or subscription for payment or verification or credit.

In the preferred embodiment of the system and method, the Merchant Intermediary 105 can receive money, payment, or consideration in any number of forms, currencies, or means including credit card payments, electronic bill payments, payment from third parties that sponsor or pay for a Caller party's transactions, advertising fees, subscription fees, third party payments, other payments, fees, or benefits, or any combination of these or other forms, benefits, or consideration.

In the preferred embodiment of the present invention's system and method, the Merchant Intermediary's program on the web server will use automated processes to process transactions, to gather information, to establish accounts, to transfer funds, to verify or to authorize transactions, to bill Caller party's accounts, to transact business, to account for fees, to receive funds, or otherwise to process and to account for financial or business transactions. For example, financial transaction programs using encryption or security features on the Merchant Intermediary's network presence can request the payment and processing information from the Caller party 101, consult using a network 103 such as the Internet with credit card companies or other financial institutions to authorize transactions and process payment, receive and account for fees, and otherwise act with and by automated processes and automated programs. There are many automated programs and methods and security means and encryption schemes that currently utilize a network to process credit card transactions, authorize payment, check for fraud, and authorize financial transactions.

After paying a fee or bearing a cost, the Caller party 101 then orders or indicates on the Merchant Intermediary's network presence that the Caller party's wants his or her communication to be sent, transmitted, or directed to the Receiver's party's “electronic mailbox”, address, account, or other location or storage area.

The communication, e-mail, or mailbox function of the present invention's system or method can be accomplished in many ways. The preferred method of the communication, e-mail, or mailbox function of the system and method is using a modified version of a web-based mail or e-mail server.

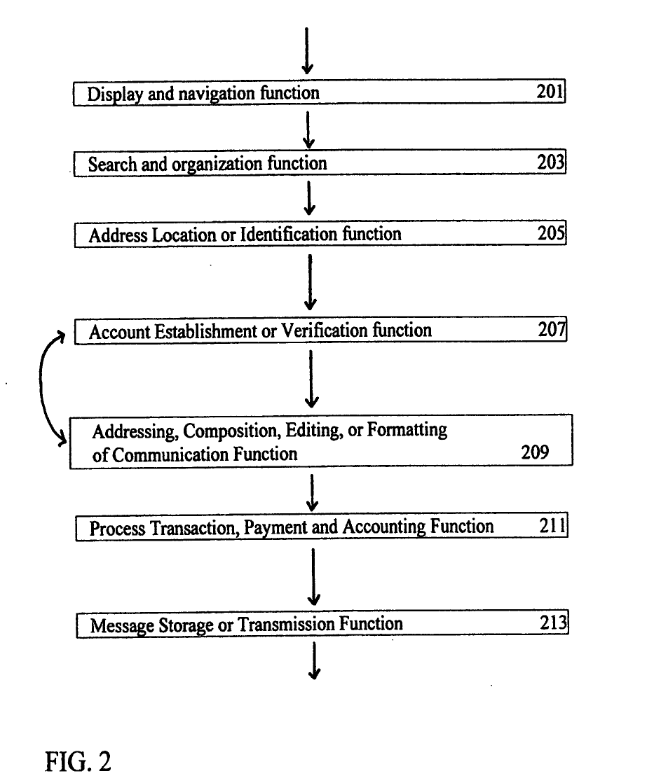

In the preferred embodiment of the invention in FIG. 2, the Merchant Intermediary's 105 web-based e-mail server establishes new and unique addresses and accounts for the Receiver party 107 that are separate and different from any other or existing e-mail addresses or communication accounts, addresses, locations, or mail-boxes that a Receiver party may have as part of using pre-existing traditional e-mail or other communication.

In the preferred embodiment of the present system and method, the Receiver's party's “electronic mailbox”, address, account, or other location or storage area can be located on the Merchant Intermediary's server or located on another server or destination, account, or address associated with the desired Receiver party. Alternative embodiments of the system and method can make use of the Receiver party's pre-existing electronic mailboxes, accounts, e-mail address, or other locations, if any.

If the Receiver party's “mailbox” account is stored on the Merchant Intermediary's web site, the Caller party's communication is held in the Receiver's party's mailbox or account. In this case, the completed communication may not be initially transmitted to another server or sent utilizing a network 103. The communication may be simply directed for storage to the Receiver party's account on the Merchant Intermediary's web site where it is stored for retrieval by the Receiver party.

Should the Receiver party 107 in FIG. 1 ask the Merchant Intermediary 105 to physically print out and mail the communications received in the account associated with the Receiver party, (for example by sending the communications via the United State Postal Service or other physical means), the completed communication may never be transmitted or transmitted over a network 103 to the Receiver party. In that case, the system and method utilize a network 103 when the Caller party 101 accesses the Merchant Intermediary's 105 web site. The system and method utilize a network 103 as the Caller party 101 is composing or sending or transmitting the communication to the Merchant Intermediary 105.

In some less preferred embodiment of the present invention and method, the Caller party 101 can using a telephone or voice communication network 103, call into the Merchant Intermediary's 105 network presence on a voice communication network and leave a voice, audio, text, or other message for the Receiver party 107. In that embodiment, the Caller party's communication is directed to the Receiver party's account or mailbox and the Caller party 101 utilizes the voice communication or telephone network 103 to access the Merchant Intermediary 105.

Utilizing a network 103 at some stage of the system or method is critical to the present invention. A network 103, as in FIG. 1, in some form is used in all embodiments of the present invention whether in situations where a network 103 is used when a Caller party's completed communication is initially or immediately transmitted to another server via a network or not. In situations where a Caller party's completed communication is initially or immediately directed for storage on the Merchant Intermediary's host computer, web-site, or mail server, the completed communication is not transmitted over or by a network 103 but the Caller Party 101 uses a network 103 to initially compose or transmit the communication to the Merchant Intermediary 105.

The present invention's system and method always make use of or utilize a network 103 such as the Internet. Even in the case where a Caller party 101 completes his communication on the Merchant Intermediary's 105 web-based server and that communication is physically mailed to the Receiver party 107 and is not transmitted to a Receiver party over a network 103, the present invention's system and method still utilizes a network 103 when the Caller party accesses the Merchant Intermediary's web site or network presence. The exact use or timing of use or utilization of the network 103 is not essential. The method and invention can make use of the network 103 in communication or transmission involving the Caller party or the Receiver party or both.

A less preferred embodiment uses a web-based server that utilizes the Caller Parties and Receiver Parties' existing mailboxes, addresses, or accounts.

A less preferred embodiment of the present invention uses a traditional mail server.

In general, to send e-mail via a mail server, a Caller party needs to have a computer or device with a connection to a network such as the Internet and access to a mail server that can transmit the Caller party's e-mail over a network such as the Internet. A Caller party also needs the address of the Receiver party.

Finding the electronic address or location of a Receiver party 107 is often not easy and often not a trivial matter. Many search engines and directories exist to attempt to provide such information. The present invention will provide a significant advantage over many of these existing paradigms because individuals will have financial incentive to provide an address through the present invention which will then be available for public Caller party to assess and use for a fee or cost.

Traditionally, when a Caller party sends an e-mail message utilizing a traditional client-server SMTP mail server, the Caller party composes the communication on his home or business computer using an e-mail program or client and adds the Receiver party's email address. When the Caller party has completed and addressed the communication, the Caller party accesses the network such as the Internet and then directs the client or e-mail program to access the mail server or host that has a network connection. The e-mail client or program passes the communication from the Caller party's computer through the modem or telephone lines to the traditional mail server computer which often uses a protocol known as a SMTP (Simple Mail Transfer Protocol). The SMTP mail server looks at the Caller party's message for the Receiver party's e-mail address, and then transmits the Caller party's message over the Internet to the destination mail server associated with the address of the Receiver party's mailbox.

When it is received, the e-mail is often stored in an electronic mailbox associated with the Receiver party on the destination mail server until the Receiver party retrieves it.

In general, to receive e-mail, a Receiver party 107 must have an “e-mail address” which is associated with an account on a traditional or web-based mail server. The mailbox is an address where messages sent to the Receiver party are stored until the Receiver party downloads or requests to view the messages. After a Receiver party connects to his or her mail server and enters his or her account name and password, the Receiver party can download or view the associated stored messages. On a traditional mail server, downloading the messages often transfers the messages from the mail server to the client application. On web based mail servers, the mail is often not automatically transferred but is viewed through or using the web browser. On a web-based mail server, the messages often stay on the web-based mail server until the Receiver party deletes or moves them.

Most Internet service providers (ISPs) and major online services offer a traditional e-mail address with every Internet access account. Web-based e-mail accounts are available, often for free, from a variety of web-based business including Yahoo!, Microsoft, hotmail, and others.

There are several main mail server implementations that could currently be implemented to effectuate the present invention's system and method.

The most preferable embodiment is a web-based mail server. For example, the most preferred embodiment entails a completely web based implementation of a separate web based mail server that utilizes independent mail boxes, accounts, or address that are established on a web server and accessible on the world wide web by a web browser.

One advantage of a web-based or browser-based e-mail system is that it allows parties with on-line access and a traditional email address to have more than one mailbox, address or account. Another advantage is that web-based or browser-based e-mail system allows parties without a traditional e-mail account to participate and to receive and send email.

One disadvantage of a web-based or browser-based e-mail system is that many on-line services have proprietary or incompatible mail protocols or standards such that mail or messages may not be uniformly processed or displayed. While all or most on-line systems provide a level of commonality or communication that is standard, some features or aspects may not be uniform. Even if they trend toward uniformity, on-line systems still have the power and ability to change their adoption or implementations of their system or standards so that remaining compatible will be an on-going effort. For example, a communication containing HTML or images sent from a Yahoo.com mail subscriber to an America-Online subscriber may not display or appear to the Receiver party exactly as intended by the Caller party.

In an alternative embodiment of the present invention, a combination of web-based and traditional mail servers would provide utility and function effectively. For example, this could involve embodiments such as a web based e-mail server and retriever that in essence enables a Caller party to transmit e-mail to an account on a traditional mail server which can be viewed by the Receiver party on a web mail viewer residing on the World Wide Web from a remote location. There are hybrids of implementations such as an independent web based WWW mail account that may be accessed by the user over the internet in multiple ways such by visiting his mail server or a world wide web site or by otherwise downloading the mail from the user's internet web based mail box to a user's traditional e-mail account or to the user's traditional e-mail client.

Less preferable alternative embodiments of the present invention utilize a traditional mail server. In the less preferred embodiments of the system and method using a traditional mail client-server application implementation, a Caller party uses mail software, called a client, to compose a message or document, possibly including tables, photographs or even a voice or video recording on his home or business computer which has access to a network such as the Internet.

Often, any information in a traditional text based mail message that is other than text must be encoded as text to be transmitted as or within a traditional mail message. There are several encoding standards such as MIME that translate the information in images, sounds, or other non-text information into text or other digital form and then retranslate them when the message is received.

Before a message is transmitted, the Caller party 101 must address it to a specific mailbox address. For example, before sending or transmitting a traditional message or e-mail over a network 103 such as the Internet, the Caller party must attach an Internet or network mail addresses to each message that is traditionally in the form of “Receiverparty@domainname.com”.

Typically, the multipart address and domain name denotes a top-level domain (“.com”) following the second-level domain (“domainname”) with an [symbol] after the individual account or address associated with the Receiver party or the Receiver party's mailbox.

Traditionally, the Caller party's computer software, using system software, standards, or protocols such as the Transmission Control Protocol (TCP), divides the message into pieces called packets and adds information to each packet about how each packet should be handled. For instance, it would tell the receiving computer or mail server information about what order packets were transmitted from the sender and how the packets should be reconstituted. The packets are typically sent from the user's home or business computer over a modem to a mail submission server, a computer on the internal network of a company or an Internet service provider.

Traditionally, a mail submission server using established protocols or standards such as SMTP converts the domain name of the recipient's mail address into a numeric Internet Protocol (IP) address. It does this by querying domain name servers interspersed throughout the Internet for the appropriate number associated with domain name. For example, the mail submission server can request from a “root” name server information pertaining to servers with information about “.com” domains. It can then interrogate the “.com” name server for the location of the specific “domainname.com” name server. A subsequent request to the “domainname.com” server will return a communication that provides the IP address for the computer that receives the mail for domainname.com. This information is then attached to each outbound message packet.

As the packets travel across the network, routers dispersed throughout the network read the IP address on a packet and relay the packet toward the address of its destination server. Individual packets of a single divided message may travel along different routes toward their destination.

Next, in the traditional paradigm, the destination mail server receives the packets and then places the divided packets back into their intended order. The destination mail server stores the message in a mailbox or other account or location associated with the Receiver party's address or account.

Lastly, the Receiver party, using a traditional mail client or other software on his home or business computer, accesses a network 103 such as the Internet for example by use of a modem. Upon request by the Receiver party, the Receiver party's client software queries the destination mail server if there is any information in the mailbox associated with the Receiver party's address or account.

Often the mail server requires that the Receiver party or client input a password or other security feature before allowing access to the account, mailbox, or address.

If there is information or mail in the Receiver party's mailbox, account or address, the Receiver party may retrieve or download the information to the client program on his home or business computer. When the mail or information is downloaded or received by the Receiver party, then the Receiver party may read it or otherwise view it using the Receiver party's client software that displays the message.

Although it is not the preferred embodiment, the present invention and its system and method could utilize all or parts of the existing standards, protocols, and infrastructure of the traditional network mail server-client paradigm.

The present invention could enable a Caller party 101 with an existing e-mail account to visit the network site or web site of a Merchant Intermediary 105 to locate an account or participation of the intended Receiver party 107. After the Caller party locates on the Merchant Intermediary's network presence or web site the participation of an intended Receiver party, the Merchant Intermediary could request that the Caller party pay a fee or bear a cost in order to receive the exact information about Receiver party's address or account.

If the Caller party pays, then the Caller party receives from the Merchant Intermediary the appropriate information or address that will allow the Caller party to transmit a communication to the account, mailbox, or address of the Receiver party.

In the preferred embodiment of this implementation, the address or account associated with the Receiver party would change dynamically or have security features so that the Caller party could only use the address or account once to transfer one message.

After the Caller party receives the address or account information, the Caller party could then use his traditional mail client to compose, to address, and to transmit a message to the account of the Receiver party.

Other alternative and less preferred embodiments of the present invention that use the standards or protocols of the traditional mail infrastructure could be implemented in any number of ways, including ways that use the Receiver party's existing mail-box account or address.

For example, other alternative embodiments of the present system and method could use the standards or protocols of the traditional mail structure on the Merchant Intermediary's network site or WWW presence or mail server to re-mail the communication received from the Caller party to a pre-existing account or address or mailbox associated with the Receiver party which may or may not be on the Merchant Intermediary's web site or under its control.

In essence, this variation of the less preferred embodiment of the present invention's method and system would be a reverse of the anonymous re-mailer paradigm. In the anonymous re-mailer paradigm, the Caller party seeks to hide or secret his identity. In this alternative variation of the invention's system and method, the Receiver party seeks to hide the exact address and account associated with the Receiver party although the Receiver party's identity is known.

In another alternative embodiment, the system and method uses a Merchant Intermediary to perform the sending or transmission function by forwarding the e-mail or communication to another address or location typically a web-based or traditional mail server.

One of the drawbacks of using the traditional mail infrastructure is that Caller parties' mail is usually downloaded to the client computer so that if the Caller party uses more than one computer the mail can be dispersed across computers and unavailable to view when the Caller party is not using the computer onto which he downloaded the mail.

Another drawback of the traditional mail server paradigm is that the Merchant Intermediary has more difficulty in limiting the amount of text in the Caller Party's communication while at the same time keeping that communication sensible and accurate. A traditional e-mail communication can be of great length. The traditional mail paradigm does not put a high premium or value on brevity. A web-based mail paradigm that puts a premium on brevity and limits the number of text characters allowed in a communication can better limit the extent of the Caller party's expression while still valuing the substance of the Caller's communication.

In the most preferred embodiment of the present invention, the Merchant Intermediary implements a web-based application or mail server.

In general, Web-based refers to applications or services that are resident on a server that is accessible using a Web browser, email client, or other software on the user's computer or device with network or internet access. The Web is usually distinguished from the Internet by the WWW's use of a standard “language” or protocol which allows computers of all different makes and models to communicate with each other and share text, graphics, images, sound, and video information.

A web-based mail server allows Caller parties with access to the World Wide Web (“WWW”) to send and receive mail from a Web site. Current example of Internet based WWW mail servers include hotmail and Yahoo.com's mail services. Web-based mail servers allow Caller parties to create a unique e-mail account on a Web site that the Caller party can then access by way of the Internet using a password. From within the web site, the Caller party can write, create, address, send, receive, and reply to e-mail from others. Often there is no direct fee or charge to use these Web based mail services.

There are several kinds of web-based mail applications. The first type of web based mail application or server lets a user with internet access read and view the mail that is in the mailbox account or address of the user's existing mail server or destination mail server. In essence, this type of application allows remote viewing of a user's e-mail from any computer with Internet access.

These types of web-based mail applications often use CGI on the web server side and Internet standards POP, SMTP, and IMAP on the e-mail side. They usually require that a user on the World Wide Web arrive at the web site of the Web-based mail server, provide the web based application with the POP id or username associated with the user's current mail server, type in an Internet address, and then enter the user's password. The web based application queries the user's traditional mail server, either downloads or receives copies of the user's mail existing in the user's mailbox on the traditional mail server, and then displays the mail on the web page.

A second and more preferable type of web based mail server enables a user to establish one or more new and independent e-mail mailboxes, accounts, and addresses that are accessible from a web browser or other application running on any computer, machine, or device with access to a network or the internet (or an intranet or other network).

Usually, the user arrives at the Web based application on the WWW and establishes a new account, a new address, a new mailbox, and a new password that are independent of any existing e-mail accounts or addresses. Often called web-mail gateways, these programs can enable users to read and process new email, send and forward messages, send and view attachments, use folders to organize messages, and use most of the common features of traditional mail client programs. Some of these Web-based email applications or gateways can either automatically delete messages from the server or leave them on the server for later downloading with a normal email client package.

An independent web based mail gateway, server, or application can usually send communication to any other address on the network or the Internet. The mail is stored in electronic mailboxes that a Receiver party accesses by entering a password and requesting to view or download the communication.

The main difference between traditional e-mail server and web based mail servers, applications or gateways is that the mail on a traditional server that use POP or POP3 is usually limited to being downloaded to the client machine and therefore may be geographically dispersed if a user has more than one device, computer, or machine on which the user reads e-mail. On the web based implementation that use standard protocol such as IMAP or IMAP 4, the mail is available from any device or location with network access and remains easily accessible.

For the purposes of the present invention, a web based mail server is preferable because it allows greater integration between the locating and identifying functions of the present invention and the transmission or direction function. The system and method will best function when the searchable database of Receiver parties or other means to locate the names or references of Receiver Parties is easily accessed and used. The WWW is now the easiest means to locate and publish this type of directory, database, or locating means. Once the Caller party has located the information associated with a Receiver party, then the Caller party may immediately begin to write a communication, pay a fee or bear a cost or obligation, and then transmit or direct the communication without having to venture to other programs or servers or locations on the network or on the Caller party's computer.

Another advantage is that this implementation can decrease the amount of communication over the Internet if the communications are stored on the Merchant Intermediary's web site. The web based email implementation cuts out the transmission from the Merchant Intermediary to the server of the Receiver Party's traditional e-mail account in situations where the Receiver Party can download or access the communication directly from the web site of the Merchant Intermediary.

A web based implementation is also preferable because in the preferred embodiment of the present invention, the Merchant Intermediary encrypts or keeps secret from the Caller party the address or location of the Receiver party's account or address, formats the Caller party's communication or transmission, transacts or processes the Caller's payment or transfers rendered, transmits or directs the Caller's communication to the account of the Receiver, and accounts to and compensates the Receiver party for participating in the system or for downloading a Caller's transmitted communications all from one integrated system.

It can be easier for the Merchant Intermediary to encrypt a message or keep a Caller Parties address secret in a web-based implementation. For example, in a web-based implementation, a Caller party never has to even enter any address information into the message, it can be automatically and secretly entered so as to prevent the Caller party from knowing the Receiver party's mailbox, address, or account information.

Additionally, a web-based implementation is advantageous because it can be easier for the Merchant Intermediary to limit or to format the length of Caller party's communication because the Merchant intermediary could just use a form box with a limited amount of character space available. For example, the web based e-mail implementation could provide a 100-character form box that a Caller party is allowed to fill.

Additionally, a web-based implementation is advantageous because it can be easier, less expensive, and faster for the Merchant Intermediary to process payment on a secure web site than with some other available means, such as manual entry of credit card or financial information given orally over the phone.

The method and system utilize a Merchant Intermediary and a web site or network presence which is represented in FIG. 2. A Merchant Intermediary, in some form, is an essential part of the system in that the Merchant Intermediary performs the method.

In the preferred embodiment of the present invention's system and method, the Merchant Intermediary engages Receiver Parties to participate; authenticates that the Receiver party is truly the party that the public recognizes or commonly associates with the name or association given by or to the Receiver party; provides Receiver Parties with secret or proprietary accounts, addresses, or mailboxes if desired; organizes a network accessible searchable database or finding function which can include information detailing participating Receiver Parties as well as communicate the price of transmitting or directing communication to a Receiver party; advertises and manages the network site or database to draw visitors and focus attention; establishes accounts for payment by Caller parties; establishes a legally binding agreement with the Caller party and between the Caller and Receiver parties; provides forum and means and common terms to publish or to negotiate terms, conditions, and variables upon which Callers and Receiver parties may agree in forming a contract, license, or agreement; provides Caller Parties with a means or form in which to communicate or transmit or direct communication to Receiver Parties; processes and receives Caller Parties payment or obligations; authorizes, processes, and accounts for financial transactions; stores, directs, or transmits the Caller party's communication to accounts, mailboxes, or addresses associated with the Receiver party; delivers or stores Caller party's communication to or in the Receiver party's account, address, or mailbox for Receiver party's access; optionally processes, filters, or formats Caller's communication for easier management, organization, or viewing by Receiver party; accounts and pays for fees and costs; and compensates Receiver Parties for participation or by arrangement or for downloading the communication.

The Merchant Intermediary takes measures to authenticate the identity and associations of the Receiver party before any communication or payment is released to the Receiver party. The Merchant Intermediary can request bank account numbers, social security numbers, and other verification or authentication data that can be used to cross check that the Receiver Party actually is who he or she claims to be.

For example, if a person proclaiming to be “Julia Roberts” the film star seeks to secure the name “Julia Roberts” on the Merchant Intermediary's web site for purposes of charging Caller parties a fee for transmitting or directing communication to an address or account associated with the actress commonly known as “Julia Roberts”, then the Merchant Intermediary may require additional information of and from the Receiver party to verify and authenticate that the person purporting to be “Julia Roberts” the film star actually is “Julia Roberts” the film star before the Merchant Intermediary accepts publication of the name, before releasing communication to the Receiver party, or before releasing funds to the Receiver party.

As illustrated in FIG. 2, the Merchant Intermediary's network presence or WWW site can be implemented in many ways. The most preferred method is to implement a WWW site with a display or graphic feature or function shown as “Display and Navigation Function” 201 in FIG. 2; a search or finding feature or function shown as “Search and Organization function” 203 in FIG. 2; an address location function shown as “Address Location or Identification function” 205 in FIG. 2; an account establishment or verification feature or function shown as “Account Establishment or Verification function” 207 in FIG. 2; an integrated addressing, direction, e-mail, text, or form input feature or function shown as “Addressing, Composition, Editing, or Formatting of Communication Function” 209 in FIG. 2; a payment or processing feature or function shown as “Process Transaction, Payment and Accounting Function” 211 in FIG. 2; and a message storage or transmission feature or function shown as “Message Storage or Transmission Function” 213 in FIG. 2.

A preferred embodiment of the Merchant Intermediary's web site display or graphic feature or function shown as “Display and Navigation Function” 201 in FIG. 2 is to utilize one or more commonly established standards or protocols such as HTML and in addition include the option of additional features using such less commonly established standards or protocols such as HTML frame format. For example, the bottom frame can be designated as the frame describing the Receiver party frame. The top frame can provide navigational controls for the Caller party to return to the Merchant Intermediary's home page or Web site. The middle frame can be used to compose a communication. This embodiment enables the Caller party to view information about the Merchant Intermediary's web site while also viewing the frame describing information related to the Receiver party. In the preferred embodiment of the present invention, a more personalized information or page may also present information relating to the cost or price of transmitting communication to the Receiver party.

Other alternative embodiments of the graphic or display feature or function shown as “Display and Navigation Function” 201 in FIG. 2 of the present system and method include a merchant web site or server which includes a controller which lists, advertises, or organizes the display or appearance of a Receiver party's availability to receive communication; lists a price for the opportunity to transmit an electronic communication; and provides Caller Parties more detailed information.

The searching or finding function or feature of the Merchant Intermediary shown as “Search and Organization function” 203 in FIG. 2 can be implemented in a number of ways. On the network presence site or server of the Merchant Intermediary, the Caller party may locate the means to access the proprietary address or account of a Receiver party.

For example, when the Caller party has located on the Merchant Intermediary's web site or network presence the name of the Receiver party that he desires, the Caller party can click on the hypertext or linked name to reach a separately identifiable page, frame, or document associated with that name.

In the preferred embodiment of the present invention, the address location or identification function or feature shown as “Address Location or Identification function” 205 in FIG. 2 can be implemented in many ways.

The address, location, or account associated with the Receiver party can be encrypted and kept secret from the Caller party such that it is unavailable to the Caller party to access without paying or to use without participating in the system or method. In the preferred embodiment of the present invention, the Caller party may only access the Receiver party's account, address, or location through the present method and system and through the payment of a fee or assumption of a cost, directly or indirectly.

The account establishment function or feature of the Merchant Intermediary shown as “Account Establishment or Verification function” 207 in FIG. 2 can be implemented in a number of ways. The Merchant Intermediary can establish accounts for Receiver Parties and for Caller parties. In certain instances, Caller Parties can also act and obtain accounts as Receiver Parties and Receiver parties can act and obtain accounts as Caller parties.

In the preferred embodiment of the present invention, the Merchant Intermediary establishes one or more unique addresses or accounts for each Receiver party. The Merchant Intermediary can agree to protect the Receiver party's privacy, encrypt the address or location of the Receiver party so that it is unknown to the Caller party, account for funds transfers or revenues generated, and agree to place communications in a secured account, address, or location that is accessible to the Receiver party.

In the preferred embodiment of the present invention, the Merchant Intermediary performs verification, authentication, and background check functions to verify, to check, or to authenticate that the person requesting service as a Receiver party actually is or is associated with the person or entity that the proposed Receiver party assumes to represent. This verification or background check could include requesting information, reference calls, meetings, or other means to verify the representations.

The Merchant Intermediary contacts or agrees with Receiver parties to participate in the system. The Merchant Intermediary agrees to directly or indirectly compensate the Receiver party for participation.

In the preferred embodiment, the Receiver party is compensated as a percentage of each communication that the Receiver party receives and downloads through the present method and system. Alternatively, the Receiver party could also be compensated by a third party such as an advertiser, by subscription fees, or otherwise benefited.

Alternatively, the Receiver party could support another charitable or other organization, person, or entity. For example, the Receiver party could choose to make the funds received from Caller parties flow to a charitable or nonprofit organization as a contribution or charity. For example, a film star may wish to support an animal rights organization. The film star would agree with the Merchant Intermediary to receive transmissions of communication from Caller parties in such a manner that the fee or cost from the Caller party benefits a third party charitable or other organization, person, or entity.

In the preferred embodiment of the present invention, the system and method also allows the Receiver party to set the price or cost of transmitting communication to the Receiver party's account. For example, the Receiver party could set the cost at $2 a transmission, $100 a transmission, or 50 cents a month for an unlimited right to send e-mails or communication.

In the preferred embodiment of the present invention, the Receiver party would have an individualized security code with which the Receiver party could use to access the web site of the Merchant Intermediary and edit the price, profile, or information associated with the Receiver party. In that way, the Receiver party could almost immediately adjust the “price” of the right to transmit communication to the Receiver party's account and make the best allocation of the Receiver party's time and resources.

In the preferred embodiment of the present invention, a page, frame, or document on the Merchant Intermediary's network presence will have a function or ability to enable a Caller party to compose, to format, or to paste a communication. The function shown as “Addressing, Composition, Editing, or Formatting of Communication Function” 209 in FIG. 2 could be in the form of a frame allowing a Caller to enter text, a word processing java applet, a graphic editor java applet, a table allowing text entry, or other modification, editing, input, forwarding, or data entry means.

In the preferred embodiment of the present invention, the Merchant Intermediary formats or processes the communication so that there is a limited amount of text or information. Brevity is important. For example, a telegram can often provide the point of a message. For example, the Merchant Intermediary could limit the communication to 500 character spaces, 10 lines, 50 words, or a photo less than 5 megabytes.

In the preferred embodiment of the present invention, the system and method provide a means to add or combine graphics, photos, sound, hyperlinks, music, multimedia, or other information or data in the communication. A client server application, by a java applet, or by other means or programming could provide this functionality.

In another embodiment, the merchant web site will limit the size and length of the Caller party's communication to a manageable form, generate immediate automated responses to the Caller party's communication that promotes the purchase of additional items related to the Receiver party, or otherwise develops or markets merchandising or additional goods or services.

In the preferred embodiment, once the Caller party has composed or formatted a communication, the Caller party can request to transmit the communication to the Receiver party's account or address. After the Caller party requests to transmit the communication, the Merchant Intermediary's server transmits a request that the Caller party pay a cost or bear a fee for the right or opportunity to transmit the communication.

In the preferred embodiment, the system or method can establish the terms of the agreement between the parties. One of the strengths of the present invention and method is that Receiver parties can price and differentiate their services and accessibility to Caller parties in a more efficient, demand-sensitive, and price sensitive manner. The present invention makes a broad and flexible range of potential terms available. A broad range of prices may also be differentiated based on the different services that may be requested by the Caller party or demanded by the Receiver party. For example, the Merchant Intermediary can notify the Caller party whether the Caller party is paying for the right to transmit communication to the account of the Receiver party or whether the Caller party is paying for a personalized response within 4 hours.

In the preferred embodiment of the present invention, the Caller party is also requested to agree to the legal terms of the communication. For example, it is at this stage, before payment or transmission, that the Caller party will agree, for example, that the Caller party grants all rights of every kind and nature in the content of the communication to the Receiver party forever, in perpetuity, and in all markets. Requiring a strong legal agreement on “idea-theft” or “Idea Submission” are important because the Receiver party is simply allowing the Caller party to access the Receiver party, not opening the Receiver party to be sued or subject to lawsuits for idea theft, copyright violations, or other potential causes of action. The legalities and terms of the use of the system should be agreed to before the communication is transmitted or payment is processed.

Payment can be in any form. The agreement, transaction, accounting, and payment function is shown as “Process Transaction, Payment, and Accounting Function” 211 in FIG. 2. The present invention seeks to remain as flexible as possible in the modes, prices, and denominations of payment. Because the present system and method seek to reduce the transaction costs of communication, the method and system offer the potential of a broad range of compensation, benefits, payments, obligations, negative cost or advertising arrangements, or other financial, beneficial, or compensatory arrangements.

In the preferred embodiment of the present invention, the Merchant Intermediary asks the Caller party to pay a fee by credit card for the price or the right to transmit communication to the Receiver party. Other arrangements are available that may provide benefits to the Receiver party including, for example, marketing arrangements where a third party compensates the Receiver party for communications received through the Merchant Intermediary, an advertising arrangement where the Caller party views or responds to advertising as a cost to the Caller party where the advertiser or the advertiser's agency compensates the Receiver party for having the Caller party view the ads or provide the information, a subscription fee where the Caller party or another party pays a fee for a limited or unlimited right to transmit or to direct communication to the Receiver party, or any arrangement where the Caller party bears a cost or pays a fee and the Receiver party receives a benefit either from the Caller party or from one or more third parties.

In the preferred embodiment of the present invention, the Merchant Intermediary will automatically or otherwise request that the Caller party establish an account, pay a subscription fee, provide personal information, or otherwise provide additional data. The additional data can be useful to the Merchant Intermediary or to the Receiver party for purposes of developing a fan base, direct marketing, follow-up communications, or other target marketing or development.

In the preferred embodiment, the Caller party pays for or bears a fee, cost, or charge associated with the communication or associated with the opportunity to access or to participate in the system of communication. In the preferred embodiment as illustrated as “Process Transaction, Payment, and Accounting Function” 211 in FIG. 2, the Caller pays for or bears the fee, cost, or charge directly through a financial transaction such as a per-communication payment charged to the Caller's credit card, directly by means of a subscription fee, indirectly through experiencing advertising, or directly or indirectly through other means or combinations thereof. In alternative embodiments, other parties pay a fee or bear a cost to compensate or benefit individual Receiver parties, the Merchant Intermediary, other parties, or combinations of these parties.

In the preferred embodiment of the present invention, the payment process is automated. There are many ways to implement an automated payment process. For instance, many credit card companies allow merchants via a network or the internet to request verification of sale or process financial transactions by enabling a merchant to transmit credit card numbers, expiration dates, amounts of sale, addresses of billed party, or other information which the credit card company or the intermediary will check against information in its own database to validate or process a sale or transaction.

The present invention or method are not dependent on any specific payment process. In the preferred embodiment of the present invention, the system or method utilize an automated payment and verification process.

After the Caller party agrees to pay a fee or cost, the Merchant Intermediary processes the transaction, bills the Caller party's account, verifies that the credit card or other information is valid, receives authorization, segregates the funds to the appropriate account associated with the individual Receiver party, accounts for the fees, or otherwise completes the financial transaction. In the preferred embodiment of the present invention, the Merchant Intermediary splits the fee received from the Caller party between the Merchant Intermediary and the Receiver party with respect to an agreement previously reached. In other financial arrangements where there may be no one single transaction, the Merchant Intermediary divides the compensation received between the Merchant Intermediary and the Receiver party or Receiver parties with respect to the terms of the agreement previously reached.

The Merchant Intermediary may also process the authorization for the fee but may not bill the Caller party's card or account until the time when the Receiver party downloads or otherwise accesses the communication or otherwise fulfills the Receiver party's obligations with respect to the terms established between the parties.

In another embodiment of the present system and method, a controller establishes an account for the Caller party, processes payment, and authorizes transactions. The controller accounts for the fees and compensates the Stars.

The method and system enable the Merchant Intermediary to maintain a maximum flexibility in the timing and manner of billing the Caller party and compensating the Receiver party. Some Receiver parties may only want to bill the Caller party for communications to which the Receiver party responds. In that case, the Merchant Intermediary will authorize the Caller party's billing information but not charge the account until the Receiver party informs the Merchant Intermediary that the Receiver party has responded to the Caller's transmission. In other cases, the Receiver party will want to bill the Caller party simply for the right to transmit communication to the Receiver party's account without regard to whether the Receiver party even views the communication. In this case, the Merchant Intermediary will bill the credit card or account of the Caller party at the time of transmitting the Caller's communication through the Merchant Intermediary.

There is obviously a vast range of potential transactions, communications, or agreements that the present system and method enable the parties to transact, to communicate, or to establish. It is important with this flexibility that the Caller party realize and know before transmitting the communication the terms of the arrangement between the Caller party and the Receiver party. In the preferred embodiment of the present invention, the Caller party will explicitly learn and agree to the terms of the communication before transmitting the communication.

In the preferred embodiment, the Caller party composes or formats the communication before paying. The Caller party could pay before he composes or formats the communication. The order of the processes is not essential.

After paying and composing the communication, the Caller party then requests to transmit the communication to an account or address that is associated with the Receiver party, often a famous or publicly known person. The transmission, direction, forwarding, or sending process is shown as “Message Storage or Transmission Function” 213 in FIG. 2. In the preferred embodiment, the transmission of the communication is through or within the Merchant Intermediary's system in that the messages are stored on servers or computers within the Merchant Intermediary's domain and stored until the Receiver party accesses them or requests that the communications be transmitted to the Receiver party.

In another embodiment of the system and method, the Caller party's communications could be transmitted to another account or address that is not within the Merchant Intermediary's domain or control, including a Receiver party's personal or existing e-mail account, or other account or address. It is preferable for the communication to reside on the Merchant Intermediary's domain so that the Merchant Intermediary knows when the Receiver party “logs” on or otherwise requests the communication to be downloaded or transmitted to the Receiver party. Although the present system and method apply to cases where the communication is re-mailed, forwarded, directed, or transmitted directly to an “outside” or existing account or address somewhere other than on the Merchant Intermediary's control or domain, the system and method provide more value when the communication is stored on the Merchant Intermediary's servers or control because then the Merchant Intermediary knows whether the Receiver party is actually interested in receiving the communication and actively seeking to download them. If the communication is automatically transmitted to an account out of the Merchant Intermediary's domain over which the Merchant Intermediary has no continuing control or oversight, then it may be unclear to the Merchant Intermediary whether the Receiver party actually ever requests, downloads, or receives the communication from the Caller parties.

Part of the value that the Caller party pays for is the opportunity to transmit communication to a location or account that is verified to be one associated or connected with the Receiver party or entity. This value could be diminished if the Receiver party's account is ignored or if in fact the Receiver party does not ever see the communication. These events may be more likely in cases where the communication is automatically forwarded to another address or account not within the Merchant Intermediary's control or observation.

In the preferred embodiment of the present invention, the Caller party will automatically receive response material as shown as shown as “Message Storage or Transmission Function” 213 in FIG. 2.

In the preferred embodiment, the Receiver's financial account is credited with funds in accord with the terms that the Receiver established with the Caller party before the transmission of the Caller's communication was consummated.

The Merchant Intermediary receives a share of the fees, costs, or obligations that Caller Party has paid or transferred. The Merchant Intermediary and the Receiver party split the revenue generated in shares and priorities determined with respect to the agreement reached between the Receiver party and the Merchant Intermediary when the Receiver party initially established an account or agreed to participate.

The timing of the billing of the Caller party is not essential. For example, if the Receiver party and the Caller party agreed that the Caller party would be billed when the Caller party transmitted the communication, then the Receiver party's account will be credited soon thereafter. For example, if the Receiver and the Caller party agreed that the Caller would only be billed if and when the Receiver party returned correspondence or responded, then the Caller party will only be billed if and when the Receiver party returns correspondence or responds. Again this flexibility is valuable in that it allows a range of different prices and services to get considered or consummated.

In the preferred embodiment, the Merchant Intermediary will bill or receive payment with respect to the Caller party as per the Caller party's agreement with the Receiver party but will hold the funds in whole or in part in a segregated account for the Receiver party until the time of payment.

After the time of billing the Caller party and prior to the time of payment to the Receiver party, the Merchant Intermediary will deduct its share of the revenue or monies generated.

The time for payment for each Receiver party may be different. For example, a Receiver party with few bill backs on the credit cards may receive a higher portion of the fees due in a more timely fashion than a Receiver party with a history of significant credit card bill backs or other charges that do not in fact generate revenue to the Receiver party or to the Merchant Intermediary. The system and method make allowances such that the Merchant Intermediary will only pass along to the Receiver party that portion of net funds that are historically or actually received in connection with the Receiver party's activity or other agreements.

In the referred embodiment of the present invention, the Receiver party will access his account on the Merchant Intermediary's web site or servers as shown as “Message Storage or Transmission Function” 213 in FIG. 2. The Receiver party will enter an account name and a security access code to gain access to the communication directed to his account. After the Receiver party's identity is confirmed by the entry of a security code previously established with Receiver party, then the Receiver party may download the Callers' communication from the Receiver's associated account to the Receiver party's remote, home, or office computer. In other cases, the Merchant Intermediary may, upon the Receiver party's request, transmit the communication directly to the Receiver party's account, print out and mail the communication to the Receiver party's geographical address, or otherwise direct or transmit the communication to the Receiver party or the designated location.

The Receiver party participates by authorizing his or her name or likeness to be used in connection with the services or advertising of the Merchant Intermediary if necessary, agrees to participate in the system, downloads or otherwise accesses the communication, and receives compensation.

In the preferred embodiment of the present invention, the Receiver party will read or view all the communications and respond to those communications that interest them. In the preferred embodiment of the present invention the Receiver party can generate an automatic response. The Receiver party can guide the Merchant Intermediary to send automated responses if the Receiver party desires or if the Receiver does not response personally.

In the preferred embodiment of the present invention the Merchant Intermediary's web-based mail server or network presence shown as “Message Storage or Transmission Function” 213 in FIG. 2 will provide functionality such as folders or other means to enable a Receiver Party to organize the communication as the Receiver Party desires, including for example organizing the received communication into categories or by types or dates. In the preferred embodiment the Merchant Intermediary will also provide services or functionality that will filter out or limit certain e-mail or communication based for example on the text of the communication or other similar such criteria. In the preferred embodiment, the Merchant Intermediary will also provide the Receiver Party with services such as automatically categorizing or organizing the received communication based on the content or prevalence of text or photos in the communications or by other factors or considerations, either developed or proposed by the Merchant Intermediary or by the Receiver party.

In the preferred embodiment of the present invention, the Merchant Intermediary can respond personally to the Caller's communication with a return communication or respond with an automated response that establishes something unique or of value to the Caller party, such as an individualized or numbered graphic or design which is transmitted digitally to the return e-mail address of the Caller party. In other embodiments, the Merchant Intermediary can respond with a communication or material by mail or otherwise.

In the preferred embodiment, the Merchant Intermediary web site will offer optional services to a Receiver party. The Merchant Intermediary web site will offer fee-based services including editing, culling, organizing, prioritizing, or otherwise processing the electronic communication so that it would be more efficient, focused, and manageable for a Receiver party to view or read the received communication.

Computers and communications and their standards are constantly changing, evolving, and improving. The present invention's system and method will benefit from the evolution of the computers and communications and is not dependent on current standards, protocols, implementations, or embodiments.

The standards, protocols, implementations, or embodiments presented are for illustrative purposes only. The standards, protocols, implementations, or embodiments described are not critical to the function of the method or system. The system or method can provide significant utility and function using one or more of many different standards, protocols, implementations, or embodiments.

As long as the system or method provides for a means to charge a fee or to cause a Caller party to bear a cost that indirectly or directly benefits the Receiver party in connection with the transmission or direction of communication or related activities, then the system and method will provide useful benefits and functionality. For example, as long as the present invention's system and method provides for a means to transmit communication from a Caller party to an account, address, or mailbox associated with a Receiver party in such a way that the Receiver party benefits financially or otherwise, the system and method provide useful benefits and functionality.

For purpose of this discussion, “Receiver party” or “Star” is any person, group, organization, or entity whom another person would know, recognize, identify, or address a communication to. “Fan”, Caller party, or “Member of the General Public” is any person who knows, recognizes, or addresses a communication to a person, group, organization, or entity. The term “know” or “known” should be defined broadly and include recognition, identification, association, or publication with, to, or by another. A “network” is any means, mechanism, or process to connect, join, transfer information, recognize, or otherwise link two or more devices, sites, locations, persons, or entities such that information or content in whatever form may be transferred or passed from one device, site, location, person, or entity to another device, site, location, person, or entity.

What I claim as my invention is:

1. A method for enabling or facilitating communication in which a Merchant Intermediary or other person or entity enables or facilitates one party to pay a fee, bear a cost, or provide consideration that in whole or in part benefits the party that receives the communication for the right or opportunity to transmit or to direct a communication to the receiver party, comprising:
i. establishing an interface, site, identifier, or network presence on one or more networks or devices;
ii. establishing addresses, accounts, identifiers, channels, codes, e-mail addresses, web site addresses, storage accounts, or other repositories, pass-through accounts, addresses, sites, or means;
iii. establishing one or more unique sites, accounts, or addresses for unique receiver parties in which the Merchant Intermediary or other person or entity may hold, segregate, or pass through information or transmissions directed to a specific Receiver, account, or address;
iv. establishing a means for a party to locate the address or account of a specific receiver party;
v. providing services or means to allow parties to create, to format, or to direct communications or transmissions to specified receiver parties;
vi. providing services or means to allow parties to pay for, to assume a cost or obligation, to charge or otherwise to bill, to account, to access benefits, to debit, to license, or otherwise to compensate or benefit the Merchant Intermediary or the Receiver;
vii. providing services or means to receive fees, to segregate benefits received, to charge parties a fee or cost or otherwise processes financial transactions or transfers associated with a party's acquiring the right or the opportunity to transmit or to direct communication to an address or account associated with a specific Receiver party;
viii. receiving, authorizing and accounting for fees, revenues, costs, and other items;
ix. transmitting, storing, holding, or distributing communication to Receiver parties or to accounts, addresses, or locations associated with Receiver parties;
x. compensating or paying Receiver parties for his or her or their participation.

2. The system of claim 1 where the communication is stored on the email server, host computer, or other device of the Merchant Intermediary or other person or entity and not transmitted immediately to another computer.

3. The system of claim 1 wherein the caller or Sender party accesses the Merchant Intermediary or other person or entity by utilizing a voice network or communicates using voice or audio information.

4. A method for rewarding a Caller or Sender Party in which a Merchant Intermediary or other person or entity enables or facilitates a Receiver party to return or transmit a communication, a personalized communication, digital collectible or other transmission or information to an account associated with the Caller or Sender Party as a reward, consideration, or to compensate the Caller or Sender Party for paying a fee, bearing a cost, or providing consideration that in whole or in part benefits the party that receives the communication, comprising:
i. establishing an interface, site, identifier, or network presence on one or more networks or devices;
ii. establishing addresses, accounts, identifiers, channels, codes, e-mail addresses, web site addresses, storage accounts, or other repositories, pass-through accounts, addresses, sites, or means;
iii. establishing one or more unique sites, accounts, or addresses for unique receiver parties in which the Merchant Intermediary or other person or entity may hold, segregate, or pass through information or transmissions directed to a specific Receiver, account, or address;
iv. establishing one or more unique sites, accounts, or addresses for unique Sender or Caller parties in which the Merchant Intermediary or other person or entity may hold, segregate, or pass through information or transmissions directed to a specific Sender or Caller Party, account, or address;
v. providing services or means to allow parties to create, to format, or to direct communications or transmissions to specified Caller or Sender parties;
vi. providing services or means to allow Receiver parties to transmit communication to Caller or Sender Parties;
vii. providing services or means to allow Caller or Sender Parties to receive communication
viii. transmitting, storing, holding, or distributing communication to Caller or Sender parties or to accounts, addresses, or locations associated with Caller or Sender parties;
ix. Providing services to allow Caller or Sender Parties to organize or to display the communication that they have received.

5. The method of claim 4, where in addition to the steps of that Method, the Merchant Intermediary or other person or entity also provides additional functionality, means, or steps comprising:
a. providing services to means to allow Caller or Sender Parties to collect, organize, exhibit, annotate, offer for sale, or otherwise display or market the communication that the Caller or sender Party has received;
b. Providing services to allow Caller or Sender Parties to offer for sale, resale, auction, or purchase, via auction or other means, the communication that Caller or Sender Party has received;
c. Providing services to allow other parties to inspect, bid on, buy or to purchase the communication that the Caller or sender Party has received;
d. Providing services to transfer upon sale the received communication in a subsequent sale from the Caller or Sender Party to the purchaser of the communication;
e. Providing services to bill, charge or otherwise cause the purchaser of the communication to pay for the communication that has been purchased;
f. Providing services to allow the payment, in whole or in part, to the sender or Caller Party the proceeds or payment resulting for the sale of the communication that the Caller or Sender Party has received;
g. Providing services that cause the Merchant Intermediary or other party person or entity to share in the sale proceeds, to bill, or to cause a charge or fee to be incurred by one or more of the Caller Party, Sender Party or Purchaser as a separate sales expense, as a percentage of the sale price, or otherwise for the sale, transaction, offer, or related endeavor.

6. The method of claim 4, where the communication or transmission services provided or the account to which the communication is sent are one or more email accounts or text based communication accounts, whether the accounts are traditional email accounts, web based email accounts, or other email or text based accounts.

7. The method of claim 4, where the organizing, collecting, annotating, exhibiting, or displaying services provided are internet based, web based, or other network based accounts, services, functionality, or means.

8. The method of claim 5, where the selling, inspecting, exhibiting, offering, reselling, auctioning, purchasing, transferring or transacting services provided are internet based, web based, or other network based accounts, services, functionality, or means.

9. The method of claim 4, where the Sender or Caller Party can not download, change, manipulate or affect the content or characteristics of the communication, digital collectible or other transmission received.

10. The method of claim 4, where the communication, digital collectible or other transmission received by the Caller or Sender Party remains on the Merchant Intermediary's or other person's or entity's web site or network presence or in the Merchant Intermediary's exclsuive control.

11. The method of claim 4, where the Merchant Intermediary or other person or entity establishes a controlled market in digital communication or digital collectibles such that the Receiver Party's return communications to the Sender Party or Caller Party are unique, are of limited edition, of verifiable authenticity, are numbered editions, are valuable because of their rarity, or otherwise not readily copied, duplicated, transferred out of the control of the Merchant Intermediary or other entity, or are otherwise controlled and maintained in a closed or propriety system.

12. The method of claim 4, where the Merchant Intermediary or other person or entity limits the copying or transmission or number of digital collectibles such that the Receiver Party's return communications to the Sender Party or Caller Party are unique, are of limited edition, of verifiable authenticity, are numbered editions, are or become desirable or valuable because of their rarity, or otherwise not readily copied, duplicated, transferred out of the control of the Merchant Intermediary or other entity, or otherwise controlled and maintained in a closed or propriety system.

13. The method of claim 4, where the Merchant Intermediary or other person or entity assists one or more Receiver Parties to create or transmit communications in such a fashion or manner to limit the copying or transmission or number of digital collectibles or communication such that the Receiver Party's return communications to the Sender Party or Caller Party are unique, are of limited edition, of verifiable authenticity, are numbered editions, are or become desirable or valuable because of their rarity, or otherwise not readily copied, duplicated, transferred out of the control of the Merchant Intermediary or other entity, or otherwise controlled and maintained in a closed or propriety system.

14. The method of claim 4, where the Merchant Intermediary or other person or entity assists one or more Caller or Sender Parties to display, organize, exhibit or otherwise show communication received from one or more Receiver Parties such that, at the Sender or Caller Parties option, the Sender Party or Caller Party may exhibit the communication, including in such a way to display the communications' characteristics as unique, of limited edition, of verifiable authenticity, of numbered editions, are or similar characteristics or values.

15. The method of claim 5, where the Merchant Intermediary or other person or entity assists one or more Caller or Sender Parties to exhibit, market, auction, offer for inspection, sell or other transact the transfer for compensation of the communication received from one or more Receiver Parties to another party in the closed system for a fee cost or compensation to be received by the Caller or Sender Party in return for the transfer of the communication or digital collectible to the buyer.

16. The method of claim 5, where the Merchant Intermediary or other person or entity keeps records, accounts, or statements of the details or specifics of each communication or digital collectible including for example the provenance of each digital collectible, the sale and transfer of each communication, of the rarity of each communication, of the specific characteristics of the communication, or makes those records available for users to consult.

17. The method of claim 5, where the Merchant Intermediary or other person or entity maintains a proprietary or secure system or database wherein it controls, tracks, verifies, or otherwise keeps secure or records all of the content, communications, exhibitions, sales, verifications, or other information and allows or authenticates communication from Receiver Parties and subsequent transactions.

18. The method of claim 4, where the Merchant Intermediary or other person or entity receives compensation for maintaining the proprietary or secure system, arrangement, organization, or database that it controls, for tracking communication, for tracking sales, for completing sales, for transferring communication, for verifying information, for allowing or authenticating communication from Receiver Parties, and otherwise receives compensation from users, Sender Parties, Caller Parties, Receiver Parties or other parties for the use of the system, arrangement, organization, for participating, or otherwise receives compensation for content, communications, exhibitions, sales, verifications, transmissions, assistance, or related information.

19. A method wherein Merchant Intermediary or other person or entity enables or facilitates a Receiver party to return or transmit one or more communications, a personalized communication, a digital collectible or other transmission or information to an account associated with the Caller or Sender Party as a reward, as consideration, or to compensate the Caller or Sender Party for paying a fee, bearing a cost, or providing consideration that in whole or in part benefits the party that receives the communication.

20. The method of claim 19, where the Merchant Intermediary or other person or entity establishes a secure or proprietary or closed system, organization, or arrangement that provides one or more unique or distinguishable identifiers or characteristics for each communication or transaction within the system, organization or arrangement.
